(19) United States
(12) Patent Application Publication
(10) Pub. No.: US 2025/0299893 A1
(43) Pub. Date: Sep. 25, 2025

(54) TRANSLUCENT KEYCAP AND METHOD OF MANUFACTURING THE SAME

(71) Applicant: DARFON ELECTRONICS CORP., TAOYUAN CITY (TW)

(72) Inventors: Yi-Tung LO, TAOYUAN CITY (TW); Tsai-Jung HU, TAOYUAN CITY (TW); Hsiao-Yuan TSAI, TAOYUAN CITY (TW)

(21) Appl. No.: 19/096,391

(22) Filed: Mar. 31, 2025

(30) Foreign Application Priority Data
Mar. 20, 2024 (TW) 113110352
Aug. 1, 2024 (TW) 113128771

(51) Int. Cl. H01H 13/08; H01H 13/02

(52) U.S. Cl. CPC H01H 13/08; H01H 13/023; H01H 2209/002; H01H 2209/038; H01H 2223/038; H01H 2223/042; H01H 2229/00

(57) ABSTRACT

A method of manufacturing a translucent keycap is firstly to form a translucent base layer to overlay a top surface and a skirt side surface of a translucent main body. Next, a light-shielding layer is formed to overlay the translucent base layer. Subsequently, a removable intermediate layer is formed to at least overlay the light-shielding layer located on the top surface. Afterward, on the removable intermediate layer over the top surface, a hollowed region is formed through the removable intermediate layer and the light-shielding layer such that the translucent base layer is exposed within the hollowed region. Then, a colored translucent layer is partially formed to cover the hollowed region and the removable intermediate layer located on a peripheral of the hollowed region. Finally, the removable intermediate layer and the colored translucent layer covering the removable intermediate layer located on the peripheral of the hollowed region are removed together.

### CROSS-REFERENCE TO RELATED APPLICATION

This utility application claims priorities to Taiwan Application Serial Number 113110352, filed Mar. 20, 2024, and Taiwan Application Serial Number 113128771, filed Aug. 1, 2024, the disclosures of which are incorporated herein by reference in their entireties.

### BACKGROUND OF THE INVENTION

### 1. Field of the invention

The invention relates to a translucent keycap and a method of manufacturing the same, and in particular, to a translucent keycap without alignment tolerance between a colored translucent layer and a light-shielding layer thereof and a method of manufacturing the same.

### 2. Description of the prior art

Regarding the manufacturing of translucent keycaps used in illuminated keyswitches, the top surface of a translucent main body is first sequentially coated with a translucent white paint layer followed by a light-shielding black paint layer. Next, a hollowed region corresponding to the desired pattern is formed on the black paint layer. This hollowed region is formed through the black paint layer such that the white paint layer is expose within the hollowed region. Subsequently, a colored translucent layer is applied to cover the hollowed region, allowing the pattern on the translucent keycap to appear in color. The light emitted from the light source of the illuminated keyswitch passes through the colored translucent layer on the keycap, rendering the pattern in color. This colored pattern represents one of the characters, numbers, symbols, or function keys.

However, the prior art of manufacturing the translucent keycap does not eliminate the alignment tolerance between the colored translucent layer and the light-shielding layer. This often resulted in defects where the colored translucent layer and the light-shielding layer partially overlap in the translucent keycap manufactured by the method of the prior art.

In addition, the translucent keycaps manufactured by the method of the prior art only display a single color effect, regardless of whether they are illuminated by the light source of the illuminated keyswitch.

### SUMMARY OF THE INVENTION

Accordingly, one scope of the invention is to provide a translucent keycap without alignment tolerance between a colored translucent layer and a light-shielding layer thereof and a method of manufacturing the same. Another scope of the invention is to provide a translucent keycap capable of displaying different color effects and a method of manufacturing the same.

A translucent keycap according to a first preferred embodiment of the invention includes a translucent main body, a translucent base layer, a light-shielding layer, a removable intermediate layer, and a colored translucent layer. The translucent main body has a top surface and a skirt side surface. The translucent base layer is formed to overlay the top surface and the skirt side surface of the translucent main body. The light-shielding layer is formed to overlay the translucent base layer. The removable intermediate layer is formed to at least overlay the light-shielding layer located on the top surface of the translucent main body. The removable intermediate layer over the top surface of the translucent main body has a hollowed region. The hollowed region is formed through the removable intermediate layer and the light-shielding layer such that the translucent base layer is exposed within the hollowed region. The colored translucent layer is locally formed to cover the hollowed region and the removable intermediate layer located on a peripheral of the hollowed region.

Further, the translucent keycap according to the first preferred embodiment of the invention also includes a transparent protective layer. After the removable intermediate layer and the colored translucent layer covering the removable intermediate layer located on the peripheral of the hollowed region are removed together, the transparent protective layer is formed to overlay the light-shielding layer and the colored translucent layer.

A modification of the translucent keycap according to the first preferred embodiment of the invention also includes a light-colored partially translucent layer and a transparent protective layer. The light-colored partially translucent layer is locally formed to at least cover the colored translucent layer. After the removable intermediate layer and the colored translucent layer and the light-colored partially translucent layer covering the removable intermediate layer located on the peripheral of the hollowed region are removed together, the transparent protective layer is formed to overlay the light-shielding layer and the light-colored partially translucent layer.

A method, according to a second preferred embodiment of the invention, of manufacturing a translucent keycap is, firstly, to prepare a translucent main body, where the translucent main body has a top surface and a skirt side surface. Next, the method according to the second preferred embodiment of the invention is to form a translucent base layer to overlay the top surface and the skirt side surface of the translucent main body. Then, the method according to the second preferred embodiment of the invention is to form a light-shielding layer to overlay the translucent base layer. Subsequently, the method according to the second preferred embodiment of the invention is to form a removable intermediate layer to at least overlay the light-shielding layer located on the top surface of the translucent main body. Afterward, the method according to the second preferred embodiment of the invention is to form a hollowed region on the removable intermediate layer over the top surface of the translucent main body. The hollowed region is formed through the removable intermediate layer and the light-shielding layer such that the translucent base layer is exposed within the hollowed region. Next, the method according to the second preferred embodiment of the invention is to locally form a colored translucent layer to cover the hollowed region and the removable intermediate layer located on a peripheral of the hollowed region. Finally, the method according to the second preferred embodiment of the invention is to remove the removable intermediate layer, where the colored translucent layer covering the removable intermediate layer located on the peripheral of the hollowed region is also removed.

In one embodiment, the removable intermediate layer can be formed of a water-based ink, a peelable adhesive, a removable light-curable resin, or other materials with removable properties.

In one embodiment, the translucent base layer can be formed of a light-colored paint.

In one embodiment, the light-shielding layer can be formed of a dark-colored paint.

In one embodiment, the colored translucent layer can be formed by a printing process or a digital inkjet process.

Further, the method according to the second preferred embodiment of the invention is to form a transparent protective layer to overlay the light-shielding layer and the colored translucent layer.

A modification of the method according to the second preferred embodiment of the invention is, between the step of locally forming a colored translucent layer and the step of removing the removable intermediate layer, to previously locally form a light-colored partially translucent layer to at least cover the colored translucent layer. During the step of removing the removable intermediate layer, the colored translucent layer and the light-colored partially translucent layer covering the removable intermediate layer located on the peripheral of the hollowed region are also removed.

Further, the modification of the method according to the second preferred embodiment of the invention is to form a transparent protective layer to overlay the light-shielding layer and the light-colored partially translucent layer.

Different from the prior art, the translucent keycap, manufactured by the method according to the invention has no alignment tolerance between the colored translucent layer and the light-shielding layer thereof. Further, the translucent keycap, manufactured by the method according to the invention is capable of displaying different color effects.

The advantage and spirit of the invention may be understood by the following recitations together with the appended drawings.

### BRIEF DESCRIPTION OF THE APPENDED DRAWINGS

FIG. 1 is a perspective view of a translucent keycap according to the first preferred embodiment of the invention.

FIG. 2 is a cross-sectional view of the translucent keycap shown in FIG. 1 along the line A-A.

FIG. 3 is a cross-sectional view of the translucent keycap, according to the first preferred embodiment of the invention, including a transparent protective layer.

FIG. 4 is a cross-sectional view of a modification of the translucent keycap according to the first preferred embodiment of the invention.

FIG. 5 through FIG. 10 are cross-sectional views schematically illustrating a method, according to the second preferred embodiment of the invention, of manufacturing a translucent keycap.

FIG. 11 is a cross-sectional view schematically illustrating a transparent protective layer further formed according to the method according to the second preferred embodiment of the invention.

FIG. 12 and FIG. 13 are cross-sectional views schematically illustrating other material layers further formed according to the method according to the second preferred embodiment of the invention.

FIG. 14 is a cross-sectional view schematically illustrating a transparent protective layer further formed on the translucent keycap shown in FIG. 13 according to the method according to the second preferred embodiment of the invention.

### DETAILED DESCRIPTION OF THE INVENTION

Some preferred embodiments and practical applications of this present invention would be explained in the following paragraph, describing the characteristics, spirit, and advantages of the invention.

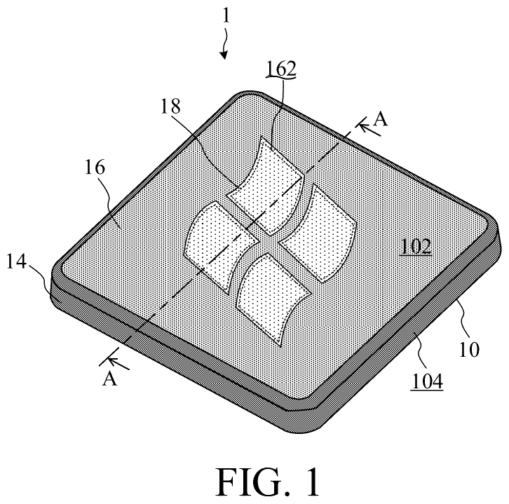

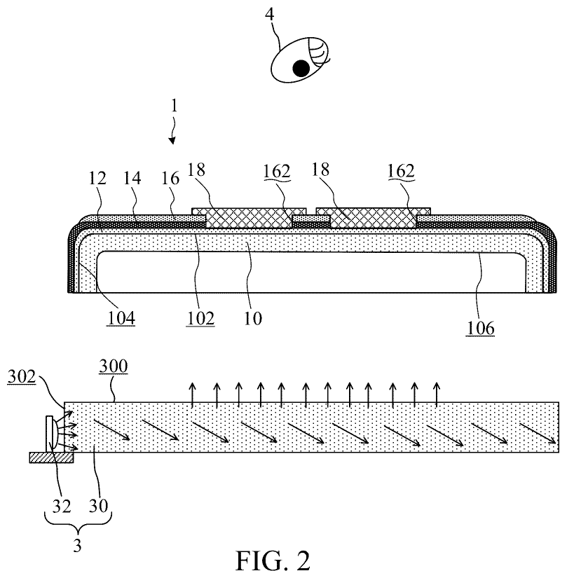

Referring to FIG. 1 and FIG. 2, FIG. 1 schematically illustrates with a perspective view the translucent keycap 1 according to the first preferred embodiment of the invention. FIG. 2 is a cross-sectional view of the translucent keycap shown in FIG. 1 along the line A-A.

As shown in FIG. 1 and FIG. 2, the translucent keycap 1 according to the first preferred embodiment of the invention includes a translucent main body 10, a translucent base layer 12, a light-shielding layer 14, a removable intermediate layer 16, and a colored translucent layer 18.

The translucent main body 10 has a top surface 102 and a skirt side surface 104. The translucent base layer 12 is formed to overlay the top surface 102 and the skirt side surface 104 of the translucent main body 10. The light-shielding layer 14 is formed to overlay the translucent base layer 12.

The removable intermediate layer 16 is formed to at least overlay the light-shielding layer 14 located on the top surface 102 of the translucent main body 10. In the example shown in FIG. 1 and FIG. 2, the removable intermediate layer 16 is formed to overlay the light-shielding layer 14 located on the top surface 102 of the translucent main body 10.

The removable intermediate layer 16 over the top surface 102 of the translucent main body 10 has a hollowed region 162. The hollowed region 162 is formed through the removable intermediate layer 16 and the light-shielding layer 14 such that the translucent base layer 12 is exposed within the hollowed region 162. The colored translucent layer 18 is locally formed to cover the hollowed region 162 and the removable intermediate layer 16 located on a peripheral of the hollowed region 162. That is to say, the area covered by the colored translucent layer 18 is larger than the hollowed region 162.

Also as shown in FIG. 2, a backlight apparatus 3 of an illuminated keyswitch is also illustrated in FIG. 2. The backlight apparatus 3 is placed below the translucent keycap 1 according to the first preferred embodiment of the invention. It should be noted that the attaching and connecting members and devices between the translucent keycap 1 and the backlight apparatus 3 according to the first preferred embodiment of the invention are not shown in FIG. 1. The backlight apparatus 3 includes a light-guiding plate 30 and a light-emitting device 32. The light-emitting device 32 is placed adjacent to a light-entering side 302 of the light-guiding plate 30. A user is also illustrated in FIG. 2. The light-emitting device 32 is driven to emit a light. The light emitted by the light-emitting device 32 enters the light-guiding plate 32 from the light-entering side 302 of the light-guiding plate 30 and is guided by the light-guiding plate 32 to emit from a front surface 300 of the light-guiding plate 32. This light then illuminates a bottom surface 106 of the translucent main body 10 of the translucent keycap 1 according to the first preferred embodiment of the invention. When the light that illuminates the bottom surface 106 of the translucent main body 10 of the translucent keycap 1 according to the first preferred embodiment of the invention is emitted from the colored translucent layer 18 on the translucent keycap 1, the user 4 will see an illuminated colored pattern displayed by the translucent keycap 1 according to the first preferred embodiment of the invention. When the light-emitting device 32 is not driven to emit the light, the user 4 will see a non-illuminated colored pattern displayed by the translucent keycap 1 according to the first preferred embodiment of the invention. The colored pattern represents one of the characters, numbers, symbols, or function keys.

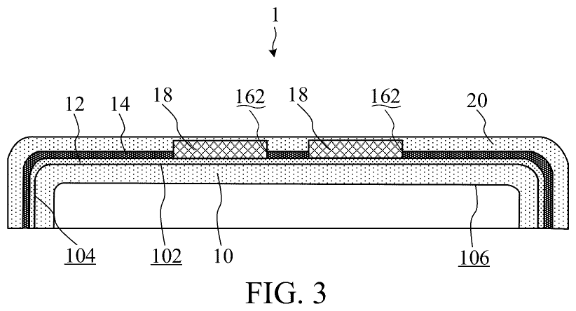

Further, the translucent keycap 1 according to the first preferred embodiment of the invention also includes a transparent protective layer 20. Referring to FIG. 3, FIG. 3 is a cross-sectional view of the translucent keycap 1, according to the first preferred embodiment of the invention, also including the transparent protective layer 20. After the removable intermediate layer 16 and the colored translucent layer 18 covering the removable intermediate layer 16 located on the peripheral of the hollowed region 162 are removed together, the transparent protective layer 20 is formed to overlay the light-shielding layer 14 and the colored translucent layer 18.

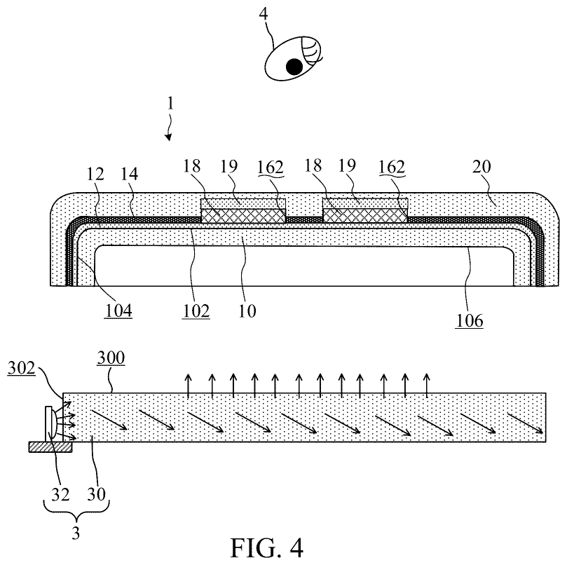

Referring to FIG. 4, FIG. 4 is a cross-sectional view of a modification of the translucent keycap 1 according to the first preferred embodiment of the invention. As shown in FIG. 4, the modification of the translucent keycap 1 according to the first preferred embodiment of the invention also includes a light-colored partially translucent layer 19 and the transparent protective layer 20. The light-colored partially translucent layer 19 is locally formed to at least cover the colored translucent layer 18. After the removable intermediate layer 16 and the colored translucent layer 18 and the light-colored partially translucent layer 19 covering the removable intermediate layer 16 located on the peripheral of the hollowed region 162 are removed together, the transparent protective layer 20 is formed to overlay the light-shielding layer 14 and the light-colored partially translucent layer 19. Also as shown in FIG. 4, the backlight apparatus 3 of the illuminated keyswitch is also shown in FIG. 4. The structure and placement of the backlight apparatus 3 in FIG. 4 are the same as the structure and placement of the backlight apparatus 3 in FIG. 3, and will be not described in detail herein. The user is also illustrated in FIG. 4. When the light emitted by the light-emitting device 32 is guided from the light-guiding plate 30 to illuminate the bottom surface 106 of the translucent main body 10 of the translucent keycap 1 according to the first preferred embodiment of the invention, the light illuminating the bottom surface 106 of the translucent main body 10 of the translucent keycap 1 will be emitted from the colored translucent layer 18 on the translucent keycap 1. The user 4 will see an illuminated colored pattern displayed by the translucent keycap 1 according to the first preferred embodiment of the invention. The colored pattern represents one of the characters, numbers, symbols, or function keys. When the light-emitting device 32 is not driven to emit the light, the user 4 will see a colored pattern of the light-colored partially translucent layer 19 displayed by the translucent keycap 1 according to the first preferred embodiment of the invention. Thereby, the translucent keycap 1, according to the first preferred embodiment of the invention, is capable of displaying different color effects.

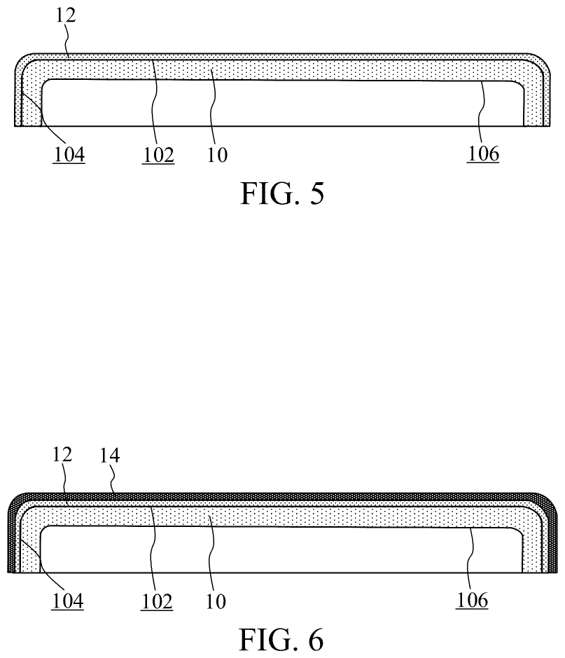

Referring to FIG. 5 through FIG. 10, these figures schematically illustrate with cross-sectional views the method, according to the second preferred embodiment of the invention, of manufacturing the translucent keycaps 1. The cross-sectional views shown in FIGS. 5 to 10 use the section line A-A defined on the translucent keycap 1 in FIG. 1.

As shown in FIG. 5, the method, according to a second preferred embodiment of the invention, of manufacturing a translucent keycap 1 is, firstly, to prepare a translucent main body 10, where the translucent main body 10 has a top surface 102 and a skirt side surface 104.

Next, also as shown in FIG. 5, the method according to the second preferred embodiment of the invention is to form a translucent base layer 12 to overlay the top surface 102 and the skirt side surface 104 of the translucent main body 10.

In one embodiment, the translucent base layer 12 can be formed of a light-colored paint. For example, the light-colored paint can be a white paint, but the invention is not limited thereto.

Then, as shown in FIG. 6, the method according to the second preferred embodiment of the invention is to form a light-shielding layer 14 to overlay the translucent base layer 12.

In one embodiment, the light-shielding layer 14 can be formed of a dark-colored paint. For example, the dark-colored paint can be a black paint, but the invention is not limited thereto.

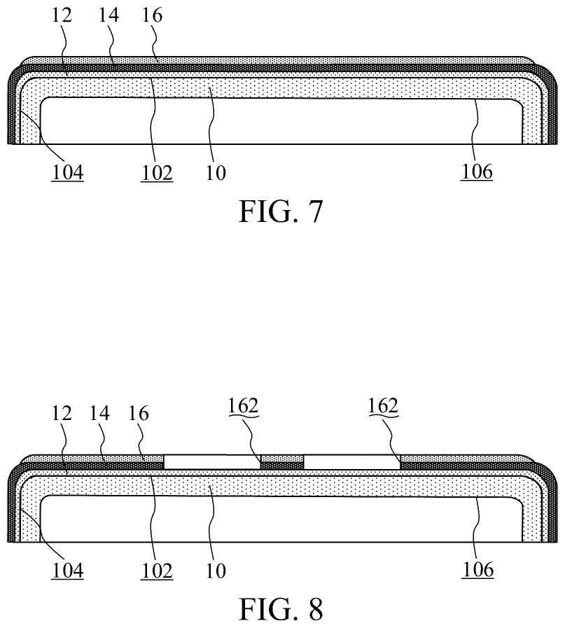

Subsequently, as shown in FIG. 7, the method according to the second preferred embodiment of the invention is to form a removable intermediate layer 16 to at least overlay the light-shielding layer 14 located on the top surface 102 of the translucent main body 10. In practice, the removable intermediate layer 16 can be extended to cover the light-shielding layer 14 located on the skirt side surface 104 of the translucent main body 10. It should be emphasized that the prior art of manufacturing the translucent keycap does not utilize the removable intermediate layer 16 as employed in the method according to the invention. In the example shown in FIG. 7, the removable intermediate layer 16 covers the light-shielding layer 14 located on the top surface 102 of the translucent main body 10.

Afterward, as shown in FIG. 8, the method according to the second preferred embodiment of the invention is to form a hollowed region 162 on the removable intermediate layer 16 over the top surface 102 of the translucent main body 10. The hollowed region 162 is formed through the removable intermediate layer 16 and the light-shielding layer 14 such that the translucent base layer 12 is exposed within the hollowed region 162.

In one embodiment, the hollowed region 162 can be formed by a laser engraving process.

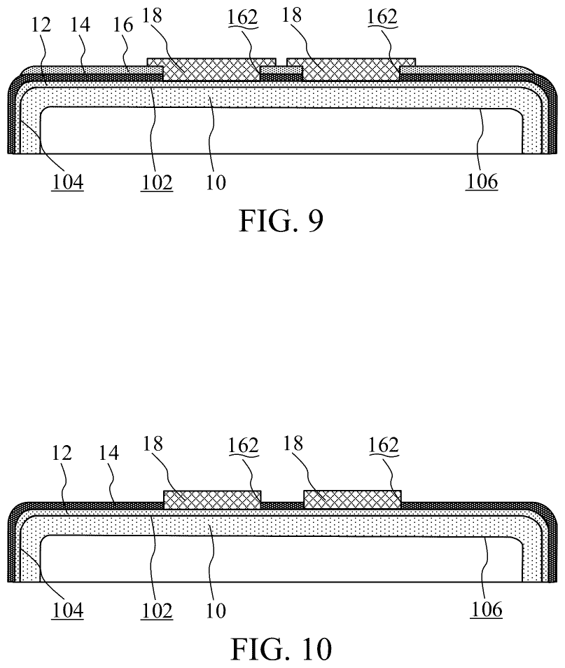

Next, as shown in FIG. 9, the method according to the second preferred embodiment of the invention is to locally form a colored translucent layer 18 to cover the hollowed region 162 and the removable intermediate layer 16 located on a peripheral of the hollowed region 162. That is to say, the area covered by the colored translucent layer 18 is larger than the hollowed region 162. It should be emphasized that the prior art of manufacturing translucent keycaps does not utilize the removable intermediate layer 16 as employed in the method according to the invention. Moreover, the prior art of manufacturing the translucent keycap directly covers the hollowed region with the colored translucent layer. However, in the translucent keycap manufactured by the prior art, there is an alignment tolerance between the colored translucent layer and the light-shielding layer, resulting in defects where the colored translucent layer and the light-shielding layer partially overlap.

In one embodiment, the colored translucent layer 18 can be formed by a printing process or a digital inkjet process. By the printing process or the digital inkjet process, the colored translucent layer 18 can present a gradually changing color effect.

Finally, as shown in FIG. 10, the method according to the second preferred embodiment of the invention is to remove the removable intermediate layer 16, where the colored translucent layer 18 covering the removable intermediate layer 16 located on the peripheral of the hollowed region 162 is also removed.

In one embodiment, the removable intermediate layer 16 can be formed of a water-based ink, a peelable adhesive, a removable light-curable resin, or other materials with removable properties. For example, the removable intermediate layer 16 is formed of a water-based ink. Subsequently, the removable intermediate layer 16, formed by the water-based ink, can be removed with water. The colored translucent layer 18 covering the removable intermediate layer 16 located on the peripheral of the hollowed region 162 will also be removed due to the loss of its adhesion base when the removable intermediate layer 16 is removed. As a result, the translucent keycap 1 manufactured by the method according to the second preferred embodiment of the invention has no alignment tolerance between the colored translucent layer 18 and the light-shielding layer 14.

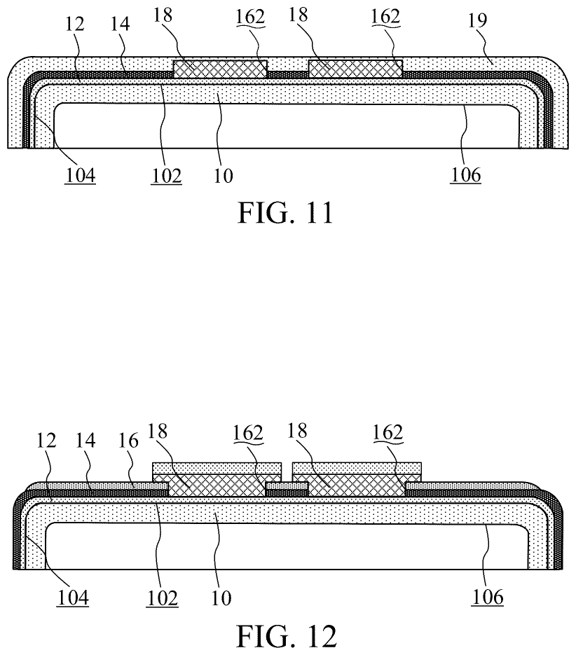

Referring to FIG. 11, FIG. 11 is a cross-sectional view schematically illustrating a transparent protective layer 20 further formed according to the method, according to the second preferred embodiment of the invention, of manufacturing the translucent keycap 1. Further, as shown in FIG. 11, the method according to the second preferred embodiment of the invention is to form the transparent protective layer 20 to overlay the light-shielding layer 14 and the colored translucent layer 18. The hardness of the transparent protective layer 20 is higher than those of the light-shielding layer 14 and the colored translucent layer 18 to prevent the light-shielding layer 14 and the colored translucent layer 18 from being worn out.

In one embodiment, the transparent protective layer 20 can be formed of an ultraviolet-curable resin, but the invention is not limited thereto

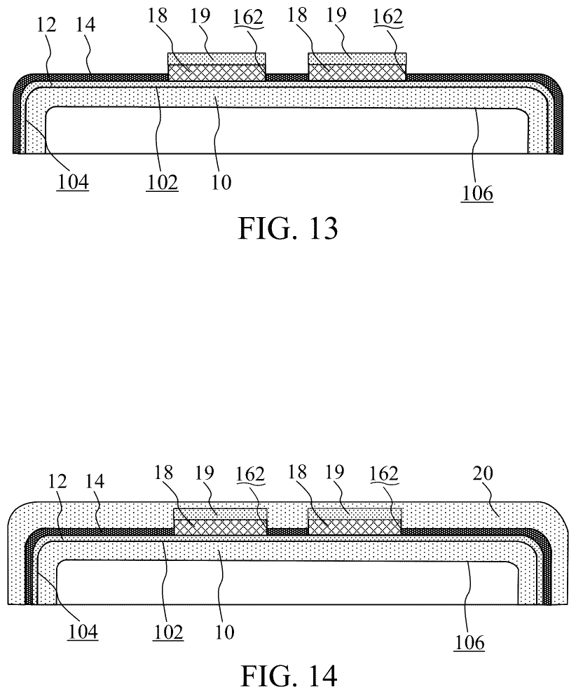

Referring to FIG. 12 and FIG. 13, FIG. 12 and FIG. 13 are cross-sectional views schematically illustrating other material layers further formed according to the method, according to the second preferred embodiment of the invention, of manufacturing the translucent keycap 1. As shown in FIG. 12, a modification of the method according to the second preferred embodiment of the invention is, between the step of locally forming a colored translucent layer 18 and the step of removing the removable intermediate layer 16, to previously locally form a light-colored partially translucent layer 19 to at least cover the colored translucent layer 18. During the step of removing the removable intermediate layer 16, the colored translucent layer 18 and the light-colored partially translucent layer 19 covering the removable intermediate layer 16 located on the peripheral of the hollowed region 162 are also removed, as shown in FIG. 13.

In one embodiment, the colored translucent layer 18 can be formed by a digital inkjet process, and subsequently, the light-colored partially translucent layer 19 can be also formed by the digital inkjet process. In another embodiment, the colored translucent layer 18 can be formed by a digital inkjet process, and subsequently, the light-colored partially translucent layer 19 can be formed by a printing process.

Referring to FIG. 14, FIG. 14 is a cross-sectional view schematically illustrating the transparent protective layer 20 further formed on the translucent keycap 1 shown in FIG. 13 according to the method according to the second preferred embodiment of the invention. Further, as shown in FIG. 14 the modification of the method according to the second preferred embodiment of the invention is to form the transparent protective layer 20 to overlay the light-shielding layer 14 and the light-colored partially translucent layer 19.

With the detailed description of the above preferred embodiments of the invention, it is clear to understand that the translucent keycap, manufactured by the method according to the invention has no alignment tolerance between the colored translucent layer and the light-shielding layer thereof. The prior art of manufacturing the translucent keycap does not utilize the removable intermediate layer as employed in the method according to the invention. Further, the translucent keycap, manufactured by the method according to the invention is capable of displaying different color effects.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method of manufacturing a translucent keycap, comprising the steps of:
(a) preparing a translucent main body, wherein the translucent main body has a top surface and a skirt side surface;
(b) forming a translucent base layer to overlay the top surface and the skirt side surface of the translucent main body;
(c) forming a light-shielding layer to overlay the translucent base layer;
(d) forming a removable intermediate layer to at least overlay the light-shielding layer located on the top surface of the translucent main body;
(e) on the removable intermediate layer over the top surface of the translucent main body, forming a hollowed region through the removable intermediate layer and the light-shielding layer such that the translucent base layer is exposed within the hollowed region;
(f) locally forming a colored translucent layer to cover the hollowed region and the removable intermediate layer located on a peripheral of the hollowed region; and
(g) removing the removable intermediate layer, wherein the colored translucent layer covering the removable intermediate layer located on the peripheral of the hollowed region is also removed.

2. The method of claim 1, wherein the removable intermediate layer is formed of one selected from the group consisting of a water-based ink, a peelable adhesive and a removable light-curable resin.

3. The method of claim 1, wherein the translucent base layer is formed of a light-colored paint, and the light-shielding layer is formed of a dark-colored paint.

4. The method of claim 1, wherein the colored translucent layer is formed by a printing process or a digital inkjet process.

5. The method of claim 1, further comprising the step of:
forming a transparent protective layer to overlay the light-shielding layer and the colored translucent layer.

6. The method of claim 1, between step (f) and step (g), further comprising the step of:
locally forming a light-colored partially translucent layer to at least cover the colored translucent layer,
wherein in step (g), the colored translucent layer and the light-colored partially translucent layer covering the removable intermediate layer located on the peripheral of the hollowed region are also removed.

7. The method of claim 6, further comprising the step of:
forming a transparent protective layer to overlay the light-shielding layer and the light-colored partially translucent layer.

8. A translucent keycap, comprising:
a translucent main body, having a top surface and a skirt side surface;
a translucent base layer, formed to overlay the top surface and the skirt side surface of the translucent main body;
a light-shielding layer, formed to overlay the translucent base layer;
a removable intermediate layer, formed to at least overlay the light-shielding layer located on the top surface of the translucent main body, wherein the removable intermediate layer over the top surface of the translucent main body has a hollowed region, the hollowed region is formed through the removable intermediate layer and the light-shielding layer such that the translucent base layer is exposed within the hollowed region; and
a colored translucent layer, locally formed to cover the hollowed region and the removable intermediate layer located on a peripheral of the hollowed region.

9. The translucent keycap of claim 8, wherein the removable intermediate layer is formed of one selected from the group consisting of a water-based ink, a peelable adhesive and a removable ultraviolet-curable resin.

10. The translucent keycap of claim 9, further comprising:
a transparent protective layer, after the removable intermediate layer and the colored translucent layer covering the removable intermediate layer located on the peripheral of the hollowed region are removed together, the transparent protective layer being formed to overlay the light-shielding layer and the colored translucent layer.

11. The translucent keycap of claim 9, further comprising:
a light-colored partially translucent layer, locally formed to at least cover the colored translucent layer; and
a transparent protective layer, after the removable intermediate layer and the colored translucent layer and the light-colored partially translucent layer covering the removable intermediate layer located on the peripheral of the hollowed region are removed together, the transparent protective layer be formed to overlay the light-shielding layer and the light-colored partially translucent layer.

12. The translucent keycap of claim 9, wherein the colored translucent layer is formed by a printing process or a digital inkjet process.
